(19) United States
(12) Patent Application Publication
(10) Pub. No.: US 2025/0348997 A1
(43) Pub. Date: Nov. 13, 2025

(54) IMAGE PROCESSING APPARATUS AND IMAGE PROCESSING METHOD

(71) Applicant: CANON KABUSHIKI KAISHA, Tokyo (JP)

(72) Inventor: YUKI DAIKU, Chiba (JP)

(21) Appl. No.: 19/202,497

(22) Filed: May 8, 2025

(30) Foreign Application Priority Data
May 13, 2024 (JP) 2024-077731

(51) Int. Cl. G06T 7/00; G06V 10/24

(52) U.S. Cl. CPC G06T 7/001; G06V 10/24; G06T 2207/30144

(57) ABSTRACT

An image processing apparatus includes: an image obtaining unit configured to read a print product in which a print image is printed on a pre-printed sheet and generate an inspection target image of the print product; a first alignment unit configured to generate an alignment image by aligning the inspection target image as a whole with a reference image by means of projection transformation, the reference image indicating a correct image of the inspection target image; and a second alignment unit configured to perform alignment by means of non-rigid registration in each of local regions of the alignment image. The second alignment unit uses at least one of a print image region surrounding the print image and a pre-printed image region surrounding a pre-printed image printed on the pre-printed sheet before printing of the print image in the alignment image as the local regions.

### BACKGROUND OF THE INVENTION

### Field of the Invention

The present disclosure relates to inspection of a print product.

### Description of the Related Art

A print product outputted from a printing apparatus is inspected to guarantee quality of the print product. In recent years, there is known a method of inspecting the print product by comparing a reference image (standard image) and an inspection target image obtained by reading the print product with a scanner in an inspection system that automatically performs the inspection. In case where the inspection is performed by comparing the images as described above, alignment of the images greatly affects accuracy of the inspection. Accordingly, it is important to perform the alignment with high accuracy.

Non-rigid registration such as free-form deformations (FFD) is known as a highly-accurate alignment technique. Using the non-rigid registration enables alignment including not only shifting and rotation of an image but also local magnification and position shifting. Accordingly, the free-form deformations enable highly-accurate alignment.

In the non-rigid registration, multiple control points for controlling the shape of an image are arranged on the image in a lattice pattern, and each of the control points is moved to transform the image. In the non-rigid registration, in order to perform transformation for aligning the inspection target image with the reference image, an error of the image is calculated, and the positions of the control points are updated one by one in such directions that this error is minimized.

Moreover, in the case where a defect such as smear of the same color as a picture is present near this picture in the inspection target image, the positions of the control points are updated such that the above-mentioned error is minimized with the defect processed as part of the picture. As a result, the control points near the defect are shifted to unexpected positions, and alignment accuracy decreases in some cases. Accordingly, in Japanese Patent Laid-Open No. 2023-33152, approximate lines of rows and columns of the control points are calculated, and the positions of the control points that have shifted to the unexpected positions are corrected based on the approximate lines.

In a use case where a print product obtained by additionally printing a print image on a pre-printed sheet is inspected, there may occur a situation in which the position of the print image with respect to a pre-printed image is shifted in the print product. In the case where this situation occurs, a process of aligning the position of the print image with respect to the pre-printed image is executed by moving the control points by means of the non-rigid registration. However, there is a case where tendency of update positions varies between the control points updated based on the pre-printed image and the control points updated based on the print image. In this case, since the approximate lines obtained based on these control points do not match neither of a group of the update positions of the control points in the pre-printed image and a group of the update positions of the control points in the print image, the control points near a defect cannot be corrected to correct positions. Moreover, the control points that essentially do not have to be corrected are corrected, and the alignment accuracy decreases in some cases.

### SUMMARY OF THE INVENTION

An image processing apparatus according to one aspect of the present disclosure includes: an image obtaining unit configured to read a print product in which a print image is printed on a pre-printed sheet and generate an inspection target image of the print product; a first alignment unit configured to generate an alignment image by aligning the inspection target image as a whole with a reference image by means of projection transformation, the reference image indicating a correct image of the inspection target image; and a second alignment unit configured to perform alignment by means of non-rigid registration in each of local regions of the alignment image, wherein the second alignment unit uses at least one of a print image region surrounding the print image and a pre-printed image region surrounding a pre-printed image printed on the pre-printed sheet before printing of the print image in the alignment image as the local regions.

Further features of the present invention will become apparent from the following description of exemplary embodiments with reference to the attached drawings.

### BRIEF DESCRIPTION OF THE DRAWINGS

FIG. 1 is a configuration diagram of an inspection system in a first embodiment;

FIG. 2 is a block diagram schematically illustrating a configuration of software modules in an inspection apparatus of FIG. 1;

FIG. 3 is a flowchart explaining an inspection process executed by the inspection apparatus of FIG. 1;

FIG. 4A is a diagram illustrating an example of print image information, FIG. 4B is a diagram illustrating an example of a pre-printed image, FIG. 4C is a diagram illustrating an example of a converted image, and FIG. 4D is a diagram illustrating an example of a reference image;

FIG. 5 is a flowchart explaining a process in S302 of FIG. 3;

FIG. 6 is a flowchart explaining a process in S306 of FIG. 3;

FIG. 7 is a diagram illustrating an example of a result display screen displayed on an UI panel in FIG. 1;

FIG. 8 is a flowchart explaining a process in S601 of FIG. 6;

FIG. 9A is a diagram illustrating a filter for highlighting a dot-shaped defect, and FIG. 9B is a diagram illustrating a filter for highlighting a linear defect;

FIG. 10 is a schematic diagram in which directions of distortion occurring in an inspection target image are illustrated by arrows;

FIG. 11A is a diagram illustrating an example of an alignment image, FIG. 11B is a diagram illustrating an arrangement example of control points, and FIG. 11C is a diagram illustrating an example of lattice points used to calculate pixels in the alignment image;

FIG. 12A is a schematic diagram illustrating an example of arrangement positions of the control points immediately after completion of update of the control points in S803, and FIG. 12B is a schematic diagram illustrating arrangement positions of the control points after execution of a control point position correction process in S806 and S807;

FIG. 13A is a flowchart explaining the control point position correction process targeted at the control points in a pre-printed image corresponding region in S806 of FIG. 8, and FIG. 13B is a flowchart explaining the control point position correction process targeted at the control points in a print image corresponding region in S807 of FIG. 8;

FIG. 14 is a diagram explaining calculation of approximate lines in S1301 of FIG. 13;

FIG. 15A is a diagram illustrating an example of a print product in which pre-printed image regions and print image regions are alternately arranged, and FIG. 15B is a diagram illustrating another example of the print product in which the pre-printed image corresponding regions and the print image corresponding regions are alternately arranged;

FIG. 16 is a flowchart explaining a second embodiment of a region designation process in S303 of FIG. 3;

FIG. 17 is a diagram explaining a situation in which a control point interval needs to be taken into consideration in the second embodiment;

FIG. 18 is a diagram illustrating an example in which control points are arranged in a third embodiment; and

FIG. 19A is a diagram illustrating a modified example of the control point position correction process illustrated in FIG. 13A, and FIG. 19B is a flowchart explaining the third embodiment of the control point position correction process in S807 of FIG. 8.

### DESCRIPTION OF THE EMBODIMENTS

Preferable embodiments of the present disclosure are explained below in detail with reference to the attached drawings. Note that the following embodiments do not limit the matters of the present disclosure, and combinations of characteristics explained in the following embodiments are not necessarily essential for solving means of the present disclosure. Note that the same constituent elements are denoted by the same reference numerals.

### [Outline]

There is a case where defects such as smear and color loss occur in a print product. Since such defects in the print product reduce quality of the print product, defect inspection of the print product is performed. For example, as the defect inspection of print product, there is inspection in which an inspection target image obtained by reading the print product with a scanner is compared with a reference image prepared in advance. In this inspection, alignment of the inspection target image and the reference image affects accuracy of the inspection. Accordingly, it is important to highly accurately perform the alignment. Non-rigid registration is known as a highly-accurate alignment technique. In the non-rigid registration, the inspection target image is set in a predetermined coordinate system. Moreover, a control point group formed of multiple control points is arranged in the predetermined coordinate system. The multiple control points are arranged in a lattice pattern. The control point group is controlled according to the position of the reference image, and at least one of the multiple control points is thereby moved. The predetermined coordinate system and the inspection target image are changed to follow this movement. Specifically, transformation of an image is performed by arranging, on the image, multiple control points for controlling the shape of the image and by updating some of the control points such that the control points in the inspection target image are aligned with the reference image. However, there is a case where a picture different from a print image is printed on a print product as in the case of a pre-printed image. In a conventional technique, comparison of the inspection target image and the reference image is performed also in this case by reading the pre-printed image and the print image together with a scanner to generate the inspection target image. However, since the pre-printed image and the print image have varying pictures, the pre-printed image and the print image vary in tendency of update positions of the control points. Accordingly, in the case where the positions of the control points are updated based on approximate lines of rows and columns derived from some of the multiple control points, there is a case where the approximate lines are not appropriate in the first place. In this case, the control points that do not have to be updated are also updated, and alignment accuracy decreases in alignment of the position of the inspection target image with the position of the reference image in some cases. Accordingly, in the present disclosure, an operation of aligning each of the pre-printed image and the print image with the reference image is performed in the case where the control points are correction targets. Specifically, the inspection target image as a whole is aligned with the reference image by means of projection transformation to generate an alignment image. Next, alignment is performed in each of local regions in the alignment image by means of non-rigid registration. At least one of a pre-printed image region surrounding the pre-printed image printed on a pre-printed sheet before printing of the print image and a print image region surrounding the print image is used as the local regions. According to this configuration, since the pre-printed image and the print image are separately aligned, it is possible to prevent a decrease in alignment accuracy even in the case where the pre-printed image and the print image have varying pictures. Embodiments of the present disclosure are described below in detail with reference to the drawings.

### First Embodiment

### Overall Configuration

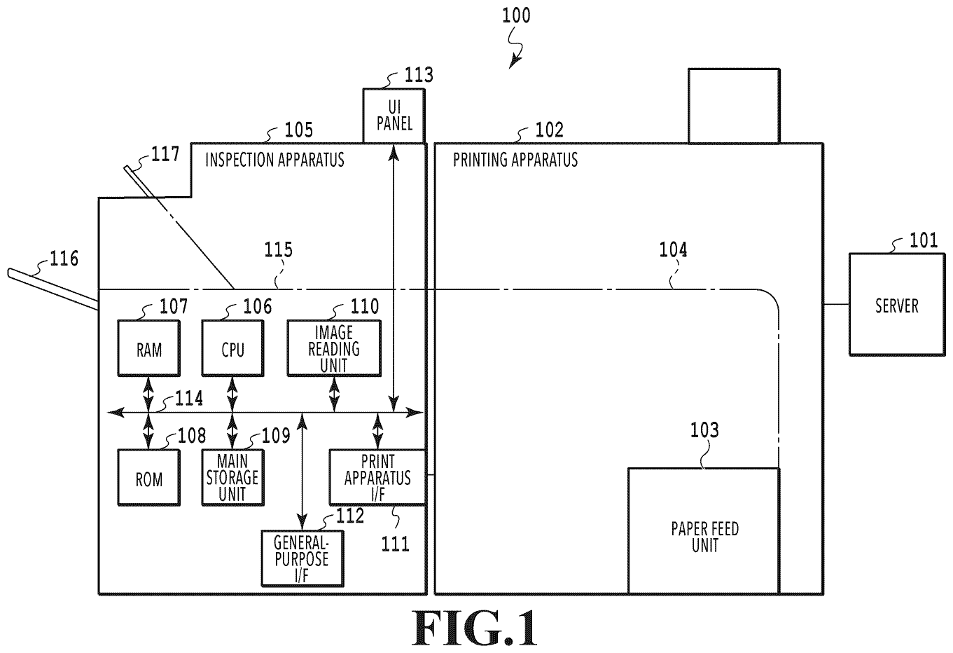

FIG. 1 is a configuration diagram of an inspection system 100 in a first embodiment. In FIG. 1, the inspection system 100 includes a server 101, a printing apparatus 102, and an inspection apparatus 105. In the inspection system 100, the printing apparatus 102 outputs a print product based on print job data generated by the server 101, and the inspection apparatus 105 inspects presence or absence of a defect in this print product.

The server 101 generates the print job data, and transmits the generated print job data to the printing apparatus 102. Not-illustrated multiple external apparatuses are communicably connected to the server 101 via a network. The server 101 receives a request of generating the print job data and the like from these external apparatuses.

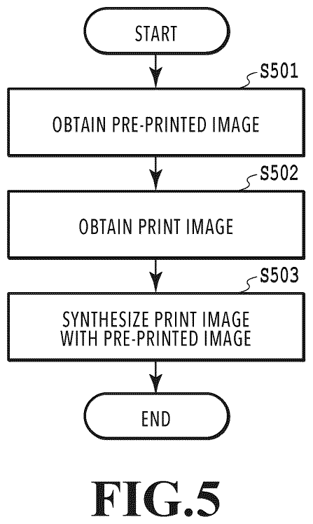

The printing apparatus 102 forms an image on a print medium such as, for example, a sheet based on the print job data received from the server 101. The print medium may be a long paper. Note that, although a configuration in which the printing apparatus 102 uses an electrophotographic method is explained in the present embodiment, the configuration is not limited to this, and may be a configuration in which the printing apparatus 102 uses another print method such as an offset printing method or an inkjet method. The printing apparatus 102 includes a paper feed unit 103. A user sets a sheet in the paper feed unit 103 in advance. The sheet set in the paper feed unit 103 is a pre-printed sheet on which a pre-printed image is printed in advance. The printing apparatus 102 conveys the sheet set in the paper feed unit 103 along a conveyance path 104, forms an image on one or both sides of the sheet, and outputs the print product on which the image is formed to the inspection apparatus 105 based on the print job data received from the server 101. Note that, in S501 of FIG. 5 to be described later in which the pre-printed image is obtained, the sheet set in the paper feed unit 103 is conveyed and outputted to the inspection apparatus 105 without the formation of image.

The inspection apparatus 105 includes a CPU 106, a RAM 107, a ROM 108, a main storage unit 109, an image reading unit 110, a print apparatus I/F 111, a general-purpose I/F 112, and a UI panel 113. The CPU 106, the RAM 107, the ROM 108, the main storage unit 109, the image reading unit 110, the print apparatus I/F 111, the general-purpose I/F 112, and the UI panel 113 are connected to one another via a main bus 114. Moreover, the inspection apparatus 105 includes a conveyance path 115 connected to the conveyance path 104 of the printing apparatus 102, an output tray 116, and an output tray 117.

The CPU 106 is a processor configured to control the entire inspection apparatus 105. The RAM 107 is functions as a main memory, a work area, or the like of the CPU 106. Multiple programs to be executed by the CPU 106 are stored in the ROM 108. Applications to be executed by the CPU 106, data to be used in an image process, and the like are stored in the main storage unit 109. The image reading unit 110 reads one or both sides of the pre-printed sheet or the print product that is the inspection target and that is outputted from the printing apparatus 102 to generate a scan image of the print product. Specifically, the image reading unit 110 reads one or both sides of the conveyed print product by using one or more reading sensors (not illustrated) provided near the conveyance path 115. The reading sensors may be provided only on one side or on both of the front and back sides of the conveyed print product to read both sides simultaneously. In a configuration in which the reading sensor is provided only on one side of the print product, the print product whose one side is read may be conveyed to a not-illustrated both-side conveyance path in the conveyance path 115, and is turned front to back to read the other side with the reading sensor.

The print apparatus I/F 111 is connected to the printing apparatus 102, and is used to achieve synchronization of a process timing of the print product with the printing apparatus 102 and to exchange operation statuses of the respective apparatuses. The general-purpose I/F 112 is a serial bus interface such as USB or IEEE 1394. For example, connecting a USB memory to the general-purpose I/F 112 allows data such as a log stored in the main storage unit 109 to be written into the USB memory and carried, and allows data stored in the USB memory to be read into the inspection apparatus 105. The UI panel 113 is, for example, a liquid crystal display (display unit). The UI panel 113 functions as a user interface of the inspection apparatus 105, and displays current status and settings to deliver the current status and settings to the user. Moreover, the UI panel 113 is a touch panel liquid crystal display. The user operates displayed buttons, and the UI panel 113 can thereby receive instructions from the user.

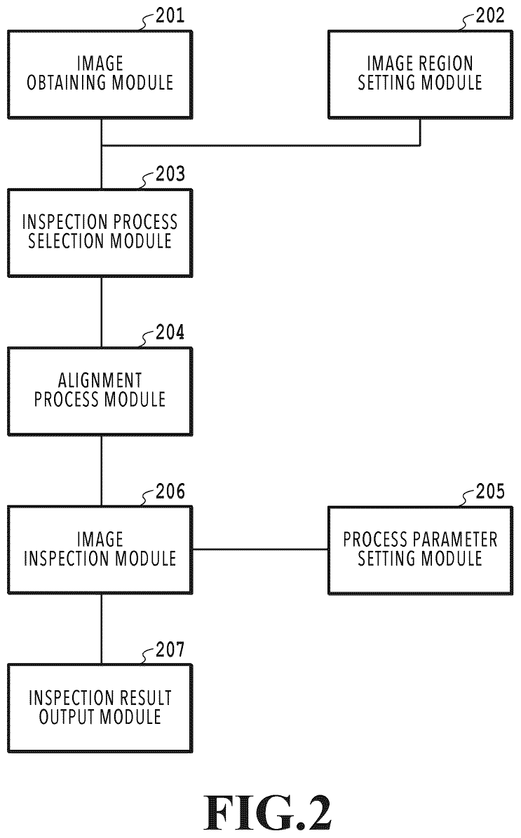

In the inspection apparatus 105, the image reading unit 110 reads the pre-printed sheet outputted from the printing apparatus 102, and generates the scan image of this sheet (hereinafter, referred to as “pre-printed image”). Moreover, in the inspection apparatus 105, an image obtaining module 201 of FIG. 2 to be described later synthesizes the pre-printed image and the print image to generate a reference image that is a correct image. Furthermore, in the inspection apparatus 105, the image reading unit 110 reads the print product that is outputted from the printing apparatus 102 and that is the inspection target to generate the scan image of this print product (hereinafter, referred to as “inspection target image”). Moreover, in the inspection apparatus 105, an image inspection module 206 of FIG. 2 to be described later compares the inspection target image and the above-mentioned reference image to inspect presence or absence of a defect in the above-mentioned print product. The defect of the print product is a defect that reduces quality of the print product such as smear that is formed by attaching of a color material such as ink or toner to an unintended portion and color loss in which the color material is insufficiently attached to a portion where an image is supposed to be formed and a color is lighter than an original color. The inspection apparatus 105 outputs the print product that has passed the inspection to the output tray 116, and outputs the print product that has failed the inspection to the output tray 117. Only the print products that are guaranteed to have a certain level of quality can be thereby collected in the output tray 116 as finished products for delivery.

### [Configuration of Software Modules]

FIG. 2 is a block diagram schematically illustrating a configuration of software modules in the inspection apparatus 105 of FIG. 1. The inspection apparatus 105 includes the various modules in FIG. 2 as the software modules. The various modules are, for example, the image obtaining module 201, an image region setting module 202, an inspection process selection module 203, and an alignment process module 204. Moreover, the various modules are, for example, a process parameter setting module 205, the image inspection module 206, and an inspection result output module 207. The CPU 106 implements processes of these various modules by reading out programs stored in the ROM 108 to the RAM 107 and executing the programs. The various modules are explained below.

The image obtaining module 201 obtains the pre-printed image or the inspection target image from the image reading unit 110. Moreover, the image obtaining module 201 obtains the print image registered in advance, from the RAM 107 or the main storage unit 109. Furthermore, the image obtaining module 201 synthesizes the obtained pre-printed image and print image to generate the reference image that is the correct image. In this case, the reference image includes the pre-printed image and the print image. Accordingly, a pre-printed image region that is a region in which the pre-printed image is generated and a print image region that is a region in which the print image is generated can be designated by referring to the reference image. The image region setting module 202 thus designates the pre-printed image region and the print image region by referring to the reference image. The inspection process selection module 203 selects a defect detection process based on information inputted by the user into a selection screen (not illustrated) displayed on the UI panel 113. In the selection screen, for example, a type of defect is selected. The inspection process selection module 203 selects a defect detection process for detecting the selected type of defect, from among multiple defect detection processes executable by the image inspection module 206. Examples of the type of detect include a dot-shaped defect and a linear (stripe) defect. Note that the type of defect is not limited to these types, and may include any type of defect such as image unevenness and a planar defect. In the case where the user does not select the type of defect, the inspection process selection module 203 selects a defect detection process set by default.

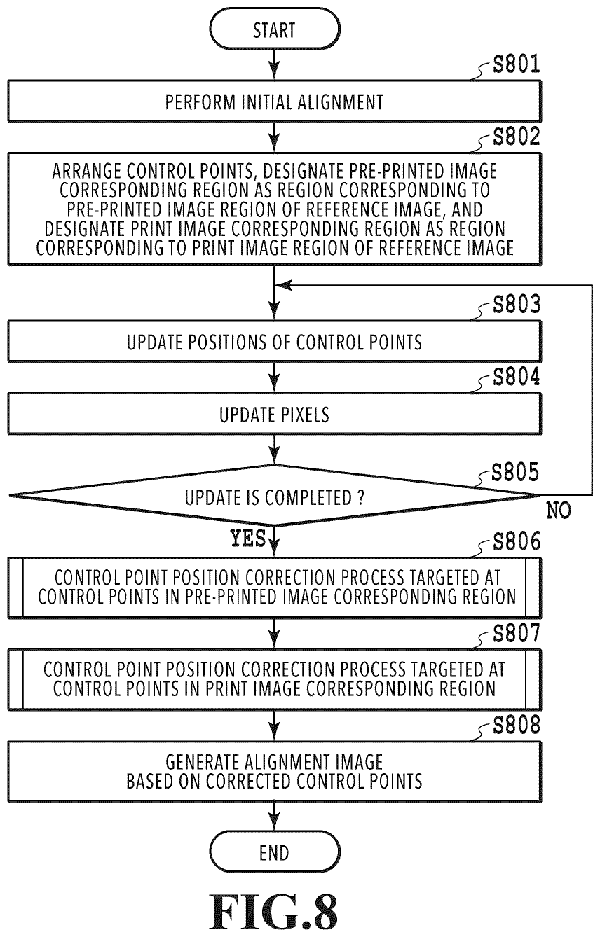

The alignment process module 204 executes an alignment process in which alignment of the inspection target image and the reference image is performed. This alignment process is described later by using FIG. 8. The process parameter setting module 205 sets parameters to be used in the defect detection process selected by the inspection process selection module 203. The parameters include a filter for highlighting the type of defect selected by the user and a defect determination threshold for determination of defect. The image inspection module 206 executes the defect detection process selected by the inspection process selection module 203. The inspection result output module 207 displays an inspection result on the UI panel 113.

### [Overall Flowchart]

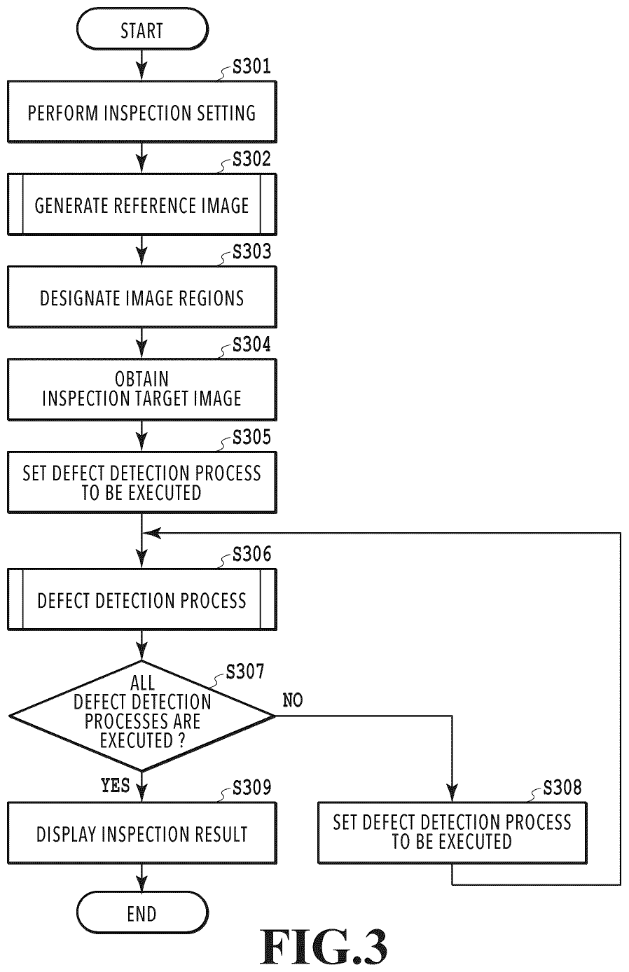

FIG. 3 is a flowchart explaining an inspection process executed by the inspection apparatus 105 of FIG. 1. The CPU 106 implements the inspection process of FIG. 3 by reading out the programs stored in the ROM 108 to the RAM 107 and executing the programs. The inspection process of FIG. 3 is executed at a timing at which the user performs an operation of starting the inspection process through the UI panel 113. Note that some or all of functions in the steps of FIG. 3 may be implemented by hardware such as an ASIC or an electronic circuit. A symbol “S” in explanation of each process means step in this flowchart.

In S301, the CPU 106 performs inspection setting necessary for inspection of the inspection target image based on information inputted by the user into the above-mentioned selection screen displayed on the UI panel 113. For example, in S301, the inspection process selection module 203 selects one or more defect detection processes based on one or more types of defects selected by the user. Moreover, the process parameter setting module 205 sets a parameter used in each of the defect detection processes selected by the inspection process selection module 203.

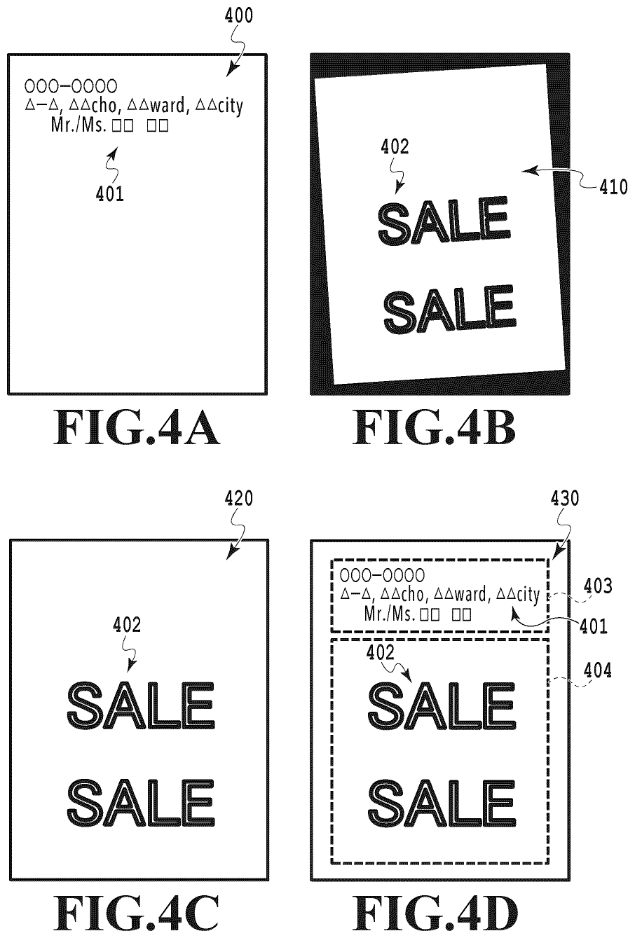

In S302, the CPU 106 executes reference image generation to generate the reference image that is the correct image. The reference image is explained by using FIGS. 4A to 4D, and the generation of the reference image is explained by using FIG. 5.

FIGS. 4A to 4D are diagrams explaining a reference image 430 generated in the process in S302 of FIG. 3. The reference image 430 includes multiple pixels forming print image information 401 and multiple pixels forming a picture 402 printed in advance on the pre-printed sheet. A print image region 403 is set to surround only the print image information 401. Moreover, a pre-printed image region 404 is set to surround the picture 402.

### [Details of S302 of FIG. 3]

FIG. 5 is a flowchart explaining the process in S302 of FIG. 3. The CPU 106 implements the generation process of reference image in FIG. 5 by reading out the programs stored in the ROM 108 to the RAM 107 and executing the programs. The generation process of reference image in FIG. 5 is executed at a timing at which the generation process of reference image in S302 of FIG. 3 is started. Note that some or all of functions in the steps of FIG. 5 may be implemented by hardware such as an ASIC or an electronic circuit. A symbol “S” in explanation of each process means step in this flowchart. In S501, the CPU 106 implements the image obtaining module 201 to cause the image reading unit 110 to read the pre-printed sheet outputted from the printing apparatus 102 and obtain a pre-printed image 410 corresponding to the pre-printed image. For example, FIG. 4B illustrates the pre-printed image 410 corresponding to the pre-printed image immediately after a moment at which the CPU 106 obtains the pre-printed image from the image reading unit 110. The CPU 106 may obtain the pre-printed image 410 corresponding to the pre-printed image held in the RAM 107 or the main storage unit 109 in advance as data, instead of obtaining the pre-printed image 410 corresponding to the pre-printed image from the image reading unit 110.

In S502, the CPU 106 implements the image obtaining module 201 to obtain the print image information 401 registered in advance from the RAM 107 or the main storage unit 109. An example of the print image information 401 is illustrated in a print image 400 in FIG. 4A corresponding to the print image. The print image information 401 is information that can be obtained by the CPU 106 from the RAM 107 or the main storage unit 109. As illustrated in FIG. 4A, an example of the print image information 401 is assumed to be rendered in the print image 400 corresponding to the print image. In FIG. 4A, a postal code, an address, and a name are rendered as the example of the print image information 401.

In S503, the CPU 106 synthesizes the pre-printed image 410 obtained by the image obtaining module 201 and corresponding to the pre-printed image and the print image 400 corresponding to the print image, and generates the reference image 430 that is the correct image. An example of a synthesizing method is described. Since the pre-printed image 410 in FIG. 4B corresponding to the pre-printed image is the image immediately after the scanning by the image reading unit 110, rotation caused by skewing of the sheet in conveyance may occur or a resolution may vary from that of the print image 400 corresponding to the print image. Accordingly, as illustrated in FIG. 4C, there is generated a converted image 420 obtained by subjecting the pre-printed image 410 to projection transformation such that apexes at four corners of the pre-printed image 410 corresponding to the pre-printed image match apexes at four corners of the print image 400 corresponding to the print image. Next, as illustrated in FIG. 4D, multiple pixels forming the print image information 401 of the print image 400 corresponding to the print image are overwritten on the converted image 420. The reference image 430 of FIG. 4D is thereby generated.

Explanation returns to FIG. 3. In S303 of FIG. 3, the CPU 106 implements the image region setting module 202 to designate the pre-printed image region 404 and the print image region 403 in the reference image 430. FIG. 4D illustrates an example of the reference image 430 generated in S302. The reference image 430 includes the multiple pixels forming the print image information 401 of the print image 400 corresponding to the print image and multiple pixels forming the picture 402 printed in advance on the pre-printed sheet. The print image region 403 is set in a region including the multiple pixels forming the print image information 401. The pre-printed image region 404 is set in a region including the multiple pixels forming the picture 402. In S303, all multiple pixels forming the print image information 401 in the reference image 430 are allocated to the print image region 403. Moreover, in S303, a region other than the print image region 403 is allocated to the pre-printed image region 404. Each of the print image region 403 and the pre-printed image region 404 is used in a control point position correction process to be described later by using FIG. 8. Note that, for example, the user may perform an operation of designating a specific portion on the reference image 430 displayed on the UI panel 113, as the print image region 403. The CPU 106 can obtain location information designating the print image region 403, based on the operation of designating the print image region 403 by the user.

In S304, the CPU 106 implements the image obtaining module 201 to obtain the inspection target image from the image reading unit 110. Note that the configuration may be such that, in S304, the image reading unit 110 obtains the inspection target image generated in advance and held in the main storage unit 109.

In S305, the CPU 106 sets one defect detection process to be executed from among the one or more defect detection processes selected by the inspection process selection module 203. In the process of S305, for example, the CPU 106 sets a defect detection process that is registered in advance to be preferentially executed or a defect detection process that corresponds to the type of defect selected first by the user.

### [Details of S306 of FIG. 3]

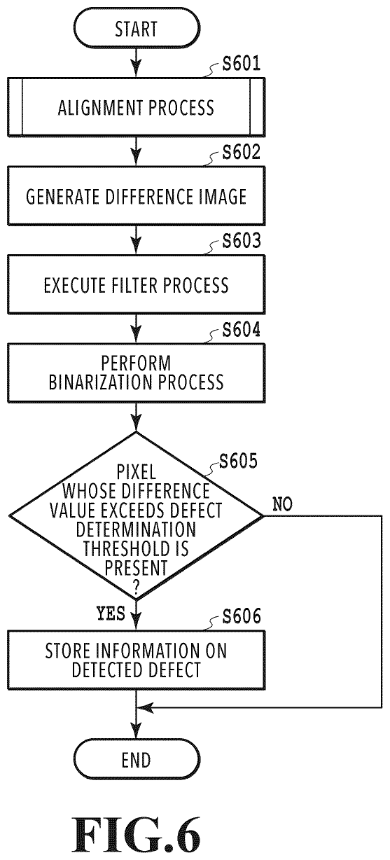

In S306, the CPU 106 executes the defect detection process. The defect detection process is explained by using FIG. 6. FIG. 6 is a flowchart explaining the process in S306 of FIG. 3. The CPU 106 implements the defect detection process of FIG. 6 by reading the programs stored in the ROM 108 out to the RAM 107 and executing the program. The defect detection process of FIG. 6 is executed at a timing at which the process in S306 of FIG. 3 is started. Specifically, the defect detection process of FIG. 6 is a subroutine of S306, and illustrates a flow of one defect detection process. Accordingly, every time the subroutine of S306 is invoked, the type of defect detection process set in the process of S305 is executed. Note that some or all of functions in the steps of FIG. 6 may be implemented by hardware such as an ASIC or an electronic circuit. A symbol “S” in explanation of each process means step in this flowchart. In S601, the CPU 106 implements the alignment process module 204 to execute the alignment process. The alignment process is a process of aligning the inspection target image and the reference image. Details of the alignment process are described later by using FIG. 8. In S602, the CPU 106 implements the image inspection module 206 to compare the aligned inspection target image and the reference image and generate a difference image. The difference image is an image generated by comparing the reference image and the inspection target image pixel by pixel and obtaining a difference value of a pixel value, for example, a density value of each of RGB for each pixel.

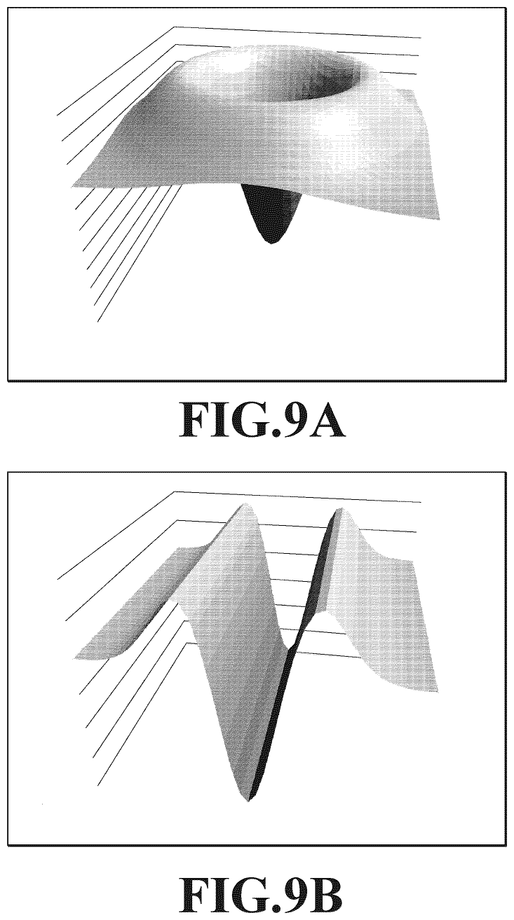

In S603, the CPU 106 implements the image inspection module 206 to execute a filter process for highlighting a specific shape, on the difference image generated in S602. FIGS. 9A and 9B are diagrams illustrating examples of a filter used in the process of S603 of FIG. 6. For example, FIG. 9A illustrates a filter for highlighting the dot-shaped defect. Meanwhile, FIG. 9B illustrates a filter for highlighting the linear defect. The filters are changed depending on the type of defect detection process set in S305 or S308. For example, in the case where the defect detection process set S305 or S308 is the defect detection process for detecting the dot-shaped defect, the filter process of S603 is executed by using the filter of FIG. 9A. Meanwhile, in the case where the defect detection process set in S305 or S308 is the defect detection process for detecting the linear defect, the filter process of S603 is executed by using the filter of FIG. 9B. The difference image subjected to the filter process is generated by the process of S603. Note that, in S603, the filter process is executed by using the filter corresponding to the type of defect detection process set in the process of S305.

In S604, the CPU 106 implements the image inspection module 206 to execute a binarization process on the difference image subjected to the filter process. This generates an image (hereinafter, referred to as “difference binarization image”) in which a pixel value of a pixel whose difference value exceeds the defect determination threshold is set to “1” and a pixel value of a pixel whose difference value is equal to or smaller than the defect determination threshold is set to “0”. In S605, the CPU 106 implements the image inspection module 206 to determine whether a pixel whose difference value exceeds the defect determination threshold is present by using the difference binarization image.

In the case where the CPU 106 determines that a pixel whose difference value exceeds the defect determination threshold is absent in S605, a defect portion is assumed to be absent, and the defect detection process is terminated. In the case where the image inspection module 206 determines that a pixel whose difference value exceeds the defect determination threshold is present in S605, in S606, the CPU 106 implements the image inspection module 206 to store information on the detected defect in the RAM 107 or the main storage unit 109. Specifically, the CPU 106 implements the image inspection module 206 to store the type of defect detection process for which the defection portion is detected in the RAM 107 or the main storage unit 109 in association with coordinates of the defect portion. Then, the defect detection process is terminated.

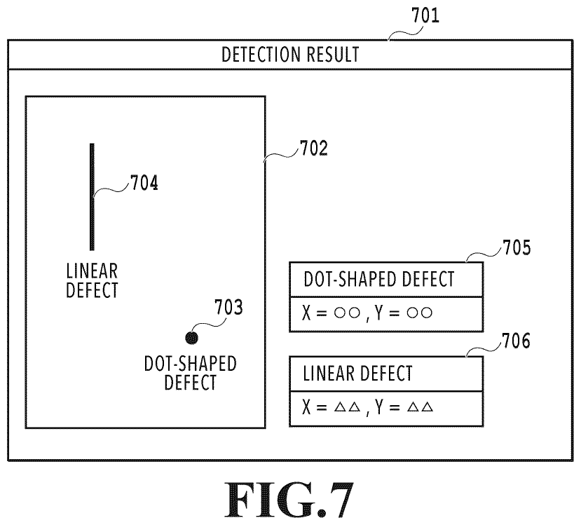

Explanation returns to FIG. 3. In S307, the CPU 106 determines whether execution of all set defect detection processes is completed or not. In the case where the CPU 106 determines that execution of any of the defect detection processes set in the process of S305 is not completed, in S308, the CPU 106 sets one defect detection process to be executed from among unexecuted defect detection processes, and the inspection process returns to S306. Meanwhile, in the case where execution of all set defect detection processes is determined to be completed in S307, in S309, the CPU 106 implements the inspection result output module 207 to display a result display screen 701 of FIG. 7 illustrating an inspection result, on the UI panel 113. FIG. 7 is a diagram illustrating an example of the result display screen 701 displayed on the UI panel 113 in FIG. 1. An inspection target image 702 is displayed in the result display screen 701 of FIG. 7. For example, characters of “dot-shaped defect” are displayed near a defect 703 determined to be the dot-shaped defect. Moreover, characters of “linear defect” are displayed near a defect 704 determined to be the linear defect. Moreover, pieces of coordinate information 705 and 706 of the respective defects in the inspection target image 702 are also displayed. Note that a display method of the inspection result is not limited to the method described above, and may be any display method in which the user can recognize in which one of the multiple defect detection processes the detected defect is detected such as, for example, displaying the types of defects in varying colors. The inspection process is terminated in the case where the process of S309 is terminated. Note that, although the defect detection process of detecting the dot-shaped defect and the defect detection process of detecting the linear defect are explained as the examples of the defect detection processes in the present embodiment, the types of defect detection processes are not limited to these. Specifically, the present disclosure can be applied to any defect detection process that can detect a defect desired by the user, and the type of defect detection process is not limited.

### [Details of S601 of FIG. 6]

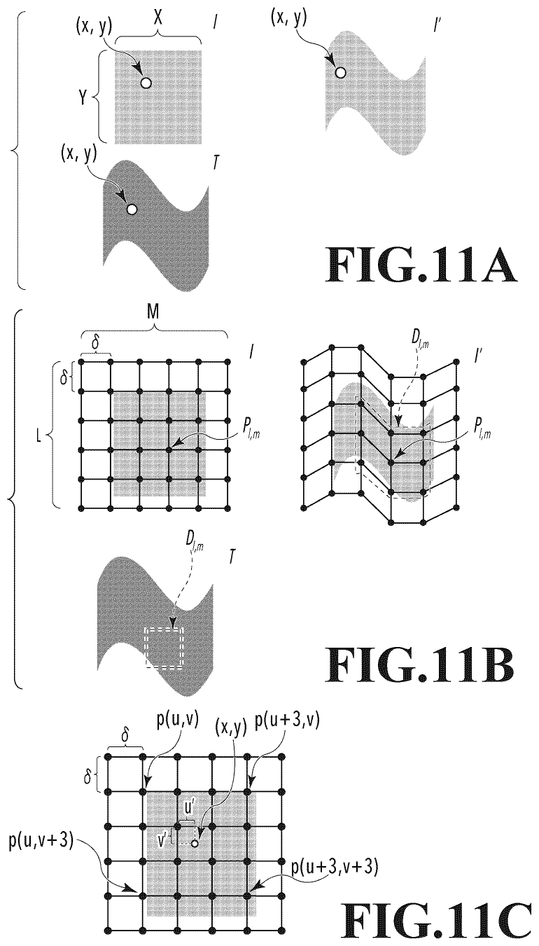

Next, details of the alignment process in S601 of FIG. 6 are explained by using FIG. 8 and FIGS. 11A to 11C. FIG. 8 is a flowchart explaining the process in S601 of FIG. 6. FIGS. 11A to 11C are diagrams illustrating a specific example of the alignment process of FIG. 8. The CPU 106 implements the alignment process of FIG. 8 by reading the programs stored in the ROM 108 out to the RAM 107 and executing the program. The alignment process of FIG. 8 is executed at a timing at which the process in S601 of FIG. 6 is started. Note that some or all of functions in the steps of FIG. 8 may be implemented by hardware such as an ASIC or an electronic circuit. A symbol “S” in explanation of each process means step in this flowchart.

In the present embodiment, explanation is given of an example in which an aligned inspection target image (hereinafter, referred to as “alignment image”) I′ illustrated in FIG. 11A and obtained by aligning an inspection target image I with a reference image T is generated. Moreover, I(x, y), T(x, y), and I′(x, y) each express the pixel value at coordinates (x, y) in a corresponding image.

In S801 of FIG. 8, the alignment process module 204 performs initial alignment. In S801, for example, the CPU 106 performs the initial alignment by extracting feature points of each of the inspection target image I and the reference image T, and performing projection transformation such that a sum of Euclidean distances between the feature points of the inspection target image I and the feature points of the reference image T is minimized. Any algorithm may be used for the extraction of feature points. For example, a general algorithm such as a corner detection algorithm of Harris, template matching, or scale-invariant feature transform (SIFT) may be used. Moreover, Mahalanobis distances may be used instead of Euclidean distances. In the process of S801, the inspection target image I is subjected to projection transformation onto the alignment image I′. Next, in S802, the alignment process module 204 arranges the control points (control point control unit). Specifically, in S802, the alignment process module 204 arranges L×M control points on the inspection target image I (scan image of print product) in a lattice pattern. Note that, since the L×M control points are arranged in the lattice pattern, a distance δ between control points is calculated from L, M, and an image size as illustrated in FIG. 11B. Moreover, as illustrated in FIG. 11B, coordinates of a control point in l-th row, m-th column is assumed to be p_{l, m} (l=1, . . . , or L, m=1, . . . , or M). Furthermore, in S802, the alignment process module 204 designates a pre-printed image corresponding region in the inspection target image I, as a region corresponding to the pre-printed image region 404 of the reference image T. Moreover, in S802, the alignment process module 204 designates a print image corresponding region in the inspection target image I, as a region corresponding to the print image region 403 of the reference image T. Note that a control point group formed of the multiple control points is assumed to be arranged in a predetermined coordinate system. Moreover, the inspection target image I, the reference image T, and the alignment image I′ are assumed to be set in the same predetermined coordinate system. Accordingly, local regions designated in the pre-printed image region 404, the pre-printed image corresponding region, the print image region 403, and the print image corresponding region are set in the same predetermined coordinate system. Accordingly, the inspection target image I is transformed to follow movement of one control point in the control point group, and the local regions are also transformed with the transformation of the inspection target image I.

Next, in S803, the alignment process module 204 updates the positions where the control points are arranged. An update formula is illustrated in formula (1) described below. In this formula, μ expresses a weight coefficient, and may be a value such as, for example, 0.1 or may be varied in synchronization with an update speed of the control points. Note that V̅_{c} is expressed by formula (2) described below. Here, V̅_{c} is a differential value of a sum of squares of differences between the pixel values of the alignment image I′ and the pixel values of the reference image T in a set D_{l, m} of positions of pixels near each control point p_{l, m} in FIG. 11B. Specifically, the first term of formula (1) arranges the L×M control points p_{l, m} in the lattice pattern. Then, the second term of formula (1) performs a process of aligning the positions of the respective control points in a range of pixels near each control point p_{l, m} in the inspection target image I, on the alignment image I′. This updates the arrangement of the control point p_{l, m} by the first term of formula (1). Then, the process of updating the control point with formula (1) is executed every time the line and the column of the control point are changed. Accordingly, in a use case in which a pixel of print defect due to smear, color loss, or the like is included in the multiple pixels near the control point p_{l, m}, such a print defect pixel is also included in the alignment image I′. Accordingly, the control point p_{l, m} near the print defect pixel causes unexpected positional shift in this use case. For example, in the case where the print defect pixel due to smear, color loss, or like is included in the pixels near the control point p_{l, m}, the second term of formula (1) updates the arrangement of the control point p_{l, m} according to the print defect pixel. A portion where a pixel of such a print result appears tends to vary between the pre-print image corresponding region and the print image corresponding region. Accordingly, in the present embodiment, the process of updating the control point is executed separately for the pre-print image corresponding region and the print image corresponding region. Note that, for example, a range including eight control points around the control point p_{l, m}, is designated as the set D_{l, m} of the positions of the pixels near the control point p_{l, m}.

$${p}_{l , m} = {p}_{l , m} + μ \frac{∇ c}{‖ ∇ c ‖} \qquad ( 1 )$$

$$∇ c = \frac{\partial }{\partial {p}_{l , m}} {\sum }_{{D}_{l , m}} {\vert {I}^{′} ( x , y ) - T ( x , y ) \vert}^{2} \qquad ( 2 )$$

In S804, the alignment process module 204 updates the pixels. An update formula is illustrated in formula (3) described below. Note that w(x, y) is expressed in formula (4) described below. Here, w(x, y) is a formula for calculating coordinates in the alignment image I′ after the alignment process of the coordinates (x, y) in the inspection target image I. Bases B₀ (t), B₁ (t), B₂ (t), and B₃ (t) in formula (4) described below are expressed by formulae (5) to (8) described below, respectively. Each of the bases B₀ (t), B₁ (t), B₂ (t), and B₃ (t) expresses a B-spline basis function. Since the B-spline basis function has locality, in the case where one control point among the multiple control points is moved, this movement affects only the control points near the one control point. Moreover, u, v, u′, and v′ illustrated in FIG. 11C are expressed by formulae (9) to (12) described below, respectively.

$${I}^{′} ( x , y ) = I ( w ( x , y ) ) \qquad ( 3 )$$

$$w ( x , y ) = {\sum }_{i = 0}^{3} {\sum }_{j = 0}^{3} {B}_{i} ( {u}^{′} ) {B}_{j} ( {v}^{′} ) {p}_{u + i , v + j} \qquad ( 4 )$$

$${B}_{0} ( t ) = {( 1 - t )}^{3} / 6 \qquad ( 5 )$$

$${B}_{1} ( t ) = ( 3 {t}^{3} - 6 {t}^{2} + 4 ) / 6 \qquad ( 6 )$$

$${B}_{2} ( t ) = ( - 3 {t}^{3} + 3 {t}^{2} + 3 t + 1 ) / 6 \qquad ( 7 )$$

$${B}_{3} ( t ) = {t}^{3} / 6 \qquad ( 8 )$$

$$u = ⌊ x / δ ⌋ - 1 \qquad ( 9 )$$

$$v = ⌊ y / δ ⌋ - 1 \qquad ( 10 )$$

$${u}^{′} = x / δ - ⌊ x / δ ⌋ \qquad ( 11 )$$

$${v}^{′} = y / δ - ⌊ y / δ ⌋ \qquad ( 12 )$$

Note that, although lattice points used to calculate the pixels in the alignment image I′ are 16 points of p(u, v), p(u+1, v), . . . , and p(u+3, v+3) in the present embodiment, the present disclosure is not limited to this. For example, the lattice points may be four lattices points whose Euclidean distances to (x, y) are small.

Next, in S805, the alignment process module 204 determines whether the update of pixels is completed or not. In S805, for example, the alignment process module 204 calculates a distance d between the pixels of the alignment image I′ and the pixels of the reference image T, and determines whether the update of pixels is completed or not based on the distance d. The distance d is illustrated in formula (13) described below.

$$d = \frac{1}{XY} {\sum }_{x = 1}^{X} {\sum }_{y = 1}^{Y} \vert {I}^{′} ( x , y ) - T ( x , y ) \vert \qquad ( 13 )$$

In S805, in the case where the distance d is equal to or smaller than a threshold set in advance, the alignment process module 204 determines that the update of pixels is completed. Meanwhile, in the case where the distance d is not equal to or smaller than the threshold set in advance, the alignment process module 204 determines that the update of pixels is completed. Note that, since the distance d is the distance between the pixels of the alignment image I′ and the pixels of the reference image T, the distance d is preferably ideally zero. However, the distance d is not zero in actual. Accordingly, the threshold is provided, and in the case where the distance d is equal to or smaller than the threshold, the alignment process module 204 completes the update of pixels. For example, the threshold is set to a distance of such a magnitude that the process causes no trouble in subsequent inspection.

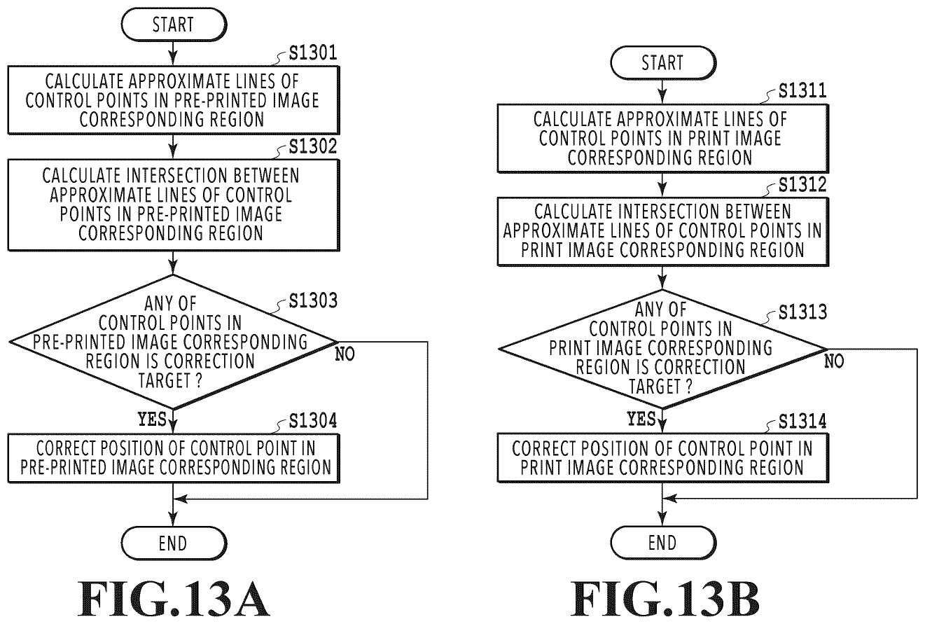

In the case where the alignment process module 204 determines that the update of pixels is not completed in S805, the alignment process returns to S803. In the case where the alignment process module 204 determines that the update of pixels is completed in S805, in S806 and S807, the alignment process module 204 performs the control point position correction process of FIGS. 13A and 13B to be described later, and corrects the positions of the control points. Then, in S808, the alignment process module 204 generates the alignment image I′ based on the corrected control points, and terminates the alignment process.

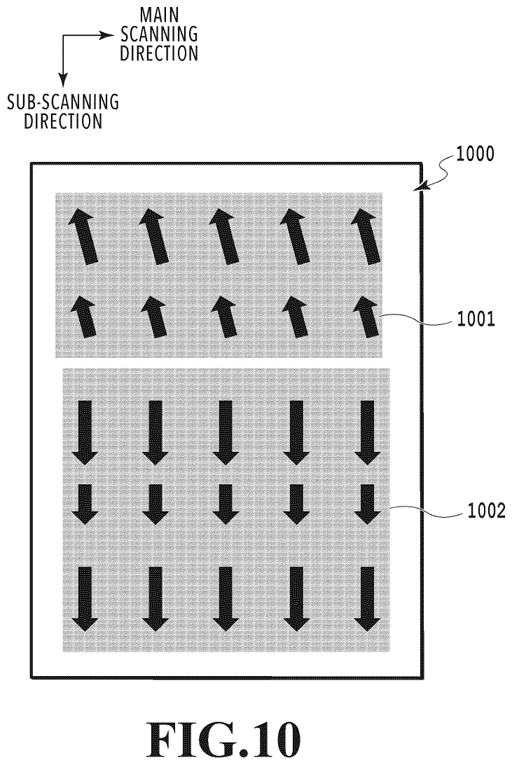

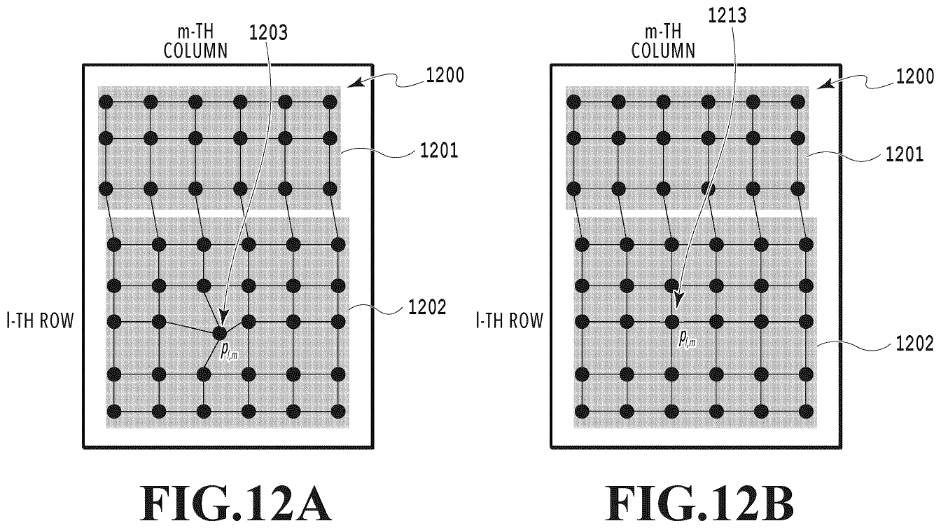

Next, the control point position correction process executed by the alignment process module 204 in S806 and S807 is explained by using FIGS. 10, 12A, 12B, 13A, 13B, and 14. FIG. 10 is a schematic diagram in which directions of distortion occurring in the inspection target image I are illustrated by arrows. In FIG. 10, a direction along a shorter direction of the sheet is assumed to be a main scanning direction. Moreover, in FIG. 10, a direction that is orthogonal to the main scanning direction and that is along a longer direction of the sheet is assumed to be a sub-scanning direction. Note that, in the following drawings, although illustration is omitted, the main scanning direction and the sub-scanning direction with respect to the sheet are assumed to be the same as those in FIG. 10. Moreover, in this explanation, the directions of distortion occurring in the inspection target image I each express a direction and a magnitude of positional shift of the inspection target image I with respect to the reference image T. Specifically, the direction of each arrow in FIG. 10 expresses the direction of the positional shift of the inspection target image I with respect to the reference image T. Moreover, the size of each arrow in FIG. 10 expresses the magnitude of the positional shift of the inspection target image I with respect to the reference image T. In FIG. 10, it is assumed that an image 1000 is the inspection target image I, only the print image is printed in a print image corresponding region 1001, and only the pre-printed image is printed in a pre-printed image corresponding region 1002. Moreover, FIGS. 12A and 12B are diagrams for explaining correction of a position where a control point is arranged. FIG. 12A is a schematic diagram illustrating an example of the arrangement positions of the control points immediately after completion of the update of control points in S803. FIG. 12B is a schematic diagram illustrating the arrangement positions of the control points after execution of the control point position correction process in S806 and S807. It is assumed that only the control point 1203 among the multiple control points is corrected to an arrangement position of a control point 1213 by the control point position correction process. Moreover, in an image 1200 of FIGS. 12A and 12B, a print image corresponding region 1201 and a pre-printed image corresponding region 1202 are designated.

In the inspection apparatus 105, in the case where the image reading unit 110 reads the print product that is the inspection target and that is outputted from the printing apparatus 102 and generates the inspection target image I, the inspection target image I has a tendency of distortion. Specifically, in the inspection target image I, the print image corresponding region 1001 and the pre-printed image corresponding region 1002 have tendencies of distortion varying from each other as illustrated in FIG. 10. Causes of this variation include shifting of the position where the printing apparatus 102 forms the print image on the pre-printed sheet. Moreover, focusing on the distortion in the pre-printed image corresponding region 1002 out of the print image corresponding region 1001 and the pre-printed image corresponding region 1002, the distortion of the pre-printed image in the pre-printed image corresponding region 1002 is uniform in the sub-scanning direction. This distortion occurs because the conveyance speed of the sheet in printing or scanning is not uniform. Moreover, although there is a case where the inspection target image I in the print image corresponding region 1001 is distorted in an oblique direction due to conveyance of the sheet in a skewed manner, the tendency of distortion in the sheet in the sub-scanning direction does not vary. Since the direction of distortion linearly changes in one region due to the above-mentioned reasons, the control points in one region are arranged on a straight line in the case where the control points are updated in S803. Accordingly, for example, a locally-shifted control point like the control point 1203 of FIG. 12A does not inherently occur. However, in the case where there is a defect of the same color as the picture is present near the picture in the inspection target image I, this defect is processed as part of this picture in the update of control points in S903, and the arrangement positions of control points are updated. As a result, there may occur a situation such as a situation where the control points near the defect are shifted to unexpected positions and the defect is included in the picture in the alignment image I′. Accordingly, there may occur a situation where alignment accuracy decreases in the case where the position of the print image is aligned with the position of the pre-printed image.

Meanwhile, in the present embodiment, the approximate line of column is calculated based on multiple control points that are arranged in the same column as one control point included in the pre-printed image corresponding region 1202 of FIGS. 12A and 12B and that are included in the pre-printed image corresponding region 1202. Moreover, the approximate line of row intersecting the above-mentioned approximate line of column is calculated based on multiple control points that are arranged in the same row as the one control point and that are included in the pre-printed image corresponding region 1202. The position of the one control point is corrected based on the above-mentioned approximate line of column and the above-mentioned approximate line of row. Furthermore, the approximate line of column is calculated based on multiple control points that are arranged in the same column as one control point included in the print image corresponding region 1201 of FIGS. 12A and 12B and that are included in the print image corresponding region 1201. Moreover, the approximate line of row intersecting the above-mentioned approximate line of column is calculated based on multiple control points that are arranged in the same row as the one control point and that are included in the print image corresponding region 1201. The position of the one control point is corrected based on the above-mentioned approximate line of column and the above-mentioned approximate line of row.

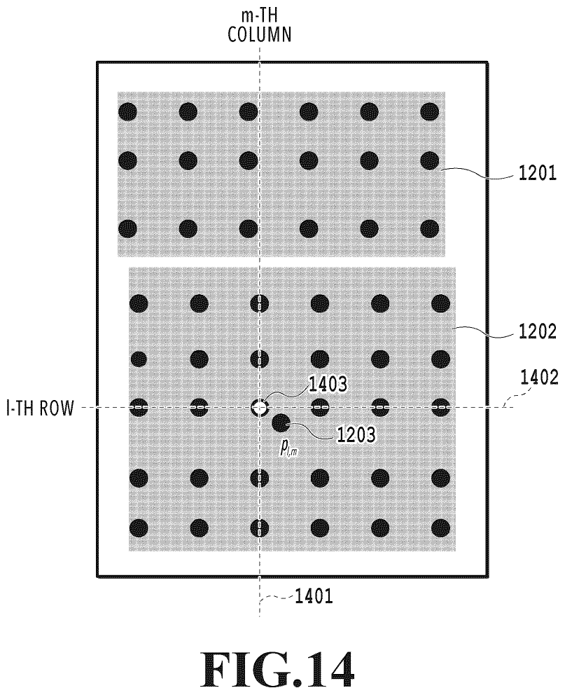

Next, the control point position correction process is explained by using FIGS. 13A, 13B, and 14. FIGS. 13A and 13B are flowcharts explaining the control point position correction process in each of S806 and S807 in FIG. 8. FIG. 13A is a flowchart explaining the control point position correction process targeted at the control points in the pre-printed image corresponding region 1202 in S806 of FIG. 8. The CPU 106 implements the control point position correction process of FIG. 13A by reading out the programs stored in the ROM 108 to the RAM 107 and executing the programs. The control point position correction process of FIG. 13A is executed at a timing at which the process of S806 of FIG. 8 is started. Note that some or all of functions in the steps of FIG. 13A may be implemented by hardware such as an ASIC or an electronic circuit. A symbol “S” in explanation of each process means step in this flowchart.

### [Details of S806 of FIG. 8]

The control point position correction process of FIG. 13A is executed on all control points arranged in the pre-printed image corresponding region corresponding to the region designated as the pre-printed image region in the process of designating the image regions in S303 of FIG. 3. In the following explanation, the case where the control point position correction process is executed on the control point 1203 of FIG. 14 among the arranged LλM control points is explained as an example. Note that the control point 1203 is the control point in l-th row, m-th column.

In S1301, the alignment process module 204 calculates the approximate lines by using the control point 1203 of FIG. 14 (approximate line calculation unit). Specifically, the alignment process module 204 calculates an approximate straight line 1401 (approximate line of column) of FIG. 14 based on the control points arranged in the pre-printed image corresponding region 1202 among the multiple control points arranged in the same column as the control point 1203, that is the m-th column. Moreover, the alignment process module 204 calculates an approximate straight line 1402 (approximate line of row) of FIG. 14 based on the control points arranged in the region designated as the pre-printed image corresponding region among the multiple control points arranged in the same row as the control point 1203, that is the l-th row. In S1301, a regression line of positions of multiple control points is used as a method of obtaining the approximate lines. For example, a regression line that predicts the y coordinate from the x coordinate in the approximate straight line 1401 is calculated by using coordinates of all control points included in the m-th column. Note that, since divergence may occur for the tilt of the regression line of the control points included in the column, a regression line that predicts the x coordinate from the y coordinate may be obtained.

In S1302, the alignment process module 204 calculates an intersection 1403 of the approximate straight line 1401 and an approximate straight line 1402. In S1303, the alignment process module 204 calculates a distance from the control point 1203 to the intersection 1403. In S1303, the alignment process module 204 determines whether the control point 1203 is a correction target or not based on the calculated distance. In S1303, in the case where the calculated distance exceeds a predetermined value, the alignment process module 204 determines that the control point 1203 is a correction target. Meanwhile, in the case where the calculated distance is equal to or smaller than the predetermined value, the alignment process module 204 determines that the control point 1203 is not a correction target. In the case where the alignment process module 204 determines that the control point 1203 is not a correction target in S1303, the alignment process module 204 terminates the correction process of the control point 1203. In the case where the alignment process module 204 determines that the control point 1203 is a correction target in S1303, in S1304, the alignment process module 204 corrects the position of the control point 1203 to the position of the intersection 1403 calculated in S1302, and terminates the correction process of the control point 1203.

### [Details of S807 of FIG. 8]

FIG. 13B is a flowchart explaining the control point position correction process targeted at the control points in the print image corresponding region 1201 in S807 of FIG. 8. The CPU 106 implements the control point position correction process of FIG. 13B by reading out the programs stored in the ROM 108 to the RAM 107 and executing the programs. The control point position correction process of FIG. 13B is executed at a timing at which the process of S807 of FIG. 8 is started. Note that some or all of functions in the steps of FIG. 13B may be implemented by hardware such as an ASIC or an electronic circuit. A symbol “S” in explanation of each process means step in this flowchart.

The control point position correction process of FIG. 13B is executed on all control points arranged in the region designated as the print image region in the image region designation process in S303 of FIG. 3. Since the specific flow of process is the same as the control point position correction process targeted at the control points in the pre-printed image corresponding region, specific explanation thereof is omitted.

According to the above-mentioned embodiment, the approximate straight line 1401 is calculated based on the control points arranged in the region where the control point 1203 is allocated, among the multiple control points arranged in the same column as the control point 1203. Moreover, the approximate straight line 1402 intersecting the approximate straight line 1401 is calculated based on the control points arranged in the region where the control point 1203 is allocated, among the multiple control points arranged in the same row as the control point 1203. Then, the position of the control point 1203 is corrected based on the approximate straight line 1401 and the approximate straight line 1402. This causes the following process to be executed even in the case where the position of the control point 1203 near the defect having the same color as the picture in the inspection target image is updated to an unexpected position by the process of S803 due to presence of the defect near the picture. Specifically, the processes of S806 and S807 can correct the position where the control point 1203 is arranged to an appropriate position by using the approximate straight line 1401 and the approximate straight line 1402. As a result, a decrease in alignment accuracy can be prevented. Specifically, the inspection target image and the reference image can be aligned at high accuracy also in the case where a predetermined image is additionally printed on a pre-printed sheet.

Moreover, in the above-mentioned embodiment, in the case where the distance from the intersection 1403 of the approximate straight line 1401 and the approximate straight line 1402 to the control point 1203 exceeds the predetermined value, the position of the control point 1203 is corrected to the position of the intersection 1403. This allows the arrangement position of the control point 1203 to be corrected according to alignment of the control points arranged in the region where the control point 1203 is allocated, among the control points arranged in the same row and the same column as the control point 1203.

Although the present disclosure has been explained above by using the above-mentioned embodiment, the present invention is not limited to the above-mentioned embodiment. For example, in the control point position correction process, approximate curves may be used instead of the approximate straight lines.

### Second Embodiment

In the first embodiment, the print product in which the print image region is printed in an upper portion of the sheet and the pre-printed image region is printed in a lower portion of the sheet as in FIGS. 4A to 4D is used as an example. In a second embodiment, the alignment process is explained by using, as an example, a print product in which the print image regions are distributed at multiple positions in the sheet.

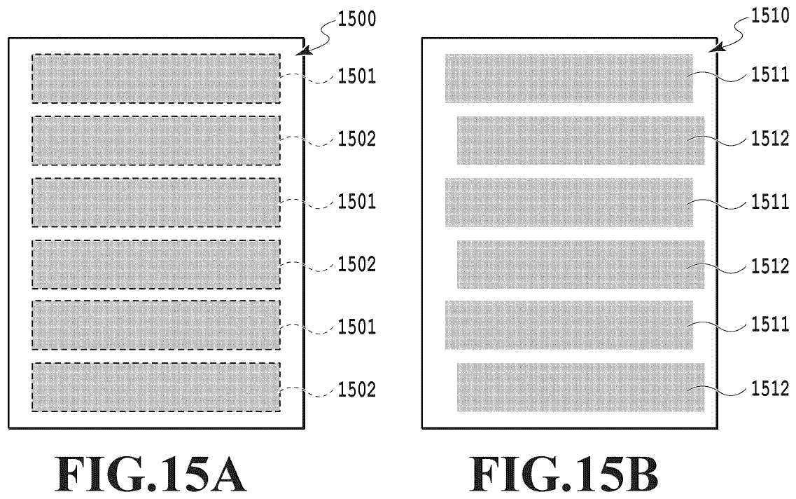

FIG. 15A illustrates an example of a print product in which pre-printed image regions 1501 and print image regions 1502 are alternately arranged. In the example of FIG. 15A, a reference image 1500 includes pre-printed images formed in the pre-printed image regions 1501 and print images formed in the print image regions 1502. Specifically, FIG. 15A illustrates an example of the reference image 1500 of the print product in which two regions are alternately distributed from the top to the bottom of the sheet. For example, in a print product such as an invoice, rule lines of a table that are the pre-printed images and characters that are the print images are alternately printed. Meanwhile, FIG. 15B illustrates an example of a print product in which pre-printed image corresponding regions 1511 and print image corresponding regions 1512 are alternately arranged. In the example of FIG. 15B, an inspection target image 1510 includes pre-printed images formed in the pre-printed image corresponding regions 1511 and print images formed in the print image corresponding regions 1512. In the example of FIG. 15B, print position shifting is occurring in the print image corresponding regions 1512 in the main scanning direction with respect to the pre-printed image corresponding regions 1511. Accordingly, print position shifting of the print images formed in the print image corresponding regions 1512 is occurring in the main scanning direction with respect to the pre-printed images formed in the pre-printed image corresponding regions 1511. In the second embodiment, explanation is given of a process of preferably aligning the inspection target image 1510 with the reference image 1500 also in such a case.

As a method of designating all print image regions in the reference image 1500 illustrated in FIG. 15A, there is a method in which the print image regions in the reference image displayed on the UI panel 113 are designated and obtained by a user operation. However, in the case where the reference image has multiple locations where regions are to be designated by the user like the reference image 1500, designation of the regions by the user operation takes time, and there is also a possibility that the control points are not allocated to a correct region due to missing of designation of a region by the user. As a result, there is a possibility that the control point position correction process is incorrectly performed and the alignment accuracy decreases. A characteristic of the present embodiment is to perform designation of the print image regions based on the print image. Only the points different from the processes of the inspection system in the first embodiment are explained below.

### [Details of S303 of FIG. 3]

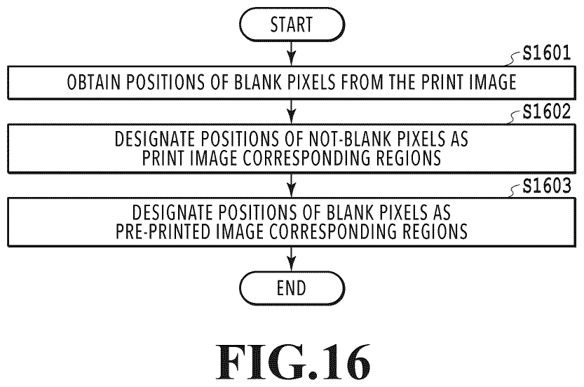

FIG. 16 is a flowchart explaining the second embodiment of the region designation process in S303 of FIG. 3. The region designation process includes a process of designating the print image regions and a process of designating the pre-printed image regions. The CPU 106 implements the region designation process of FIG. 16 by reading out the programs stored in the ROM 108 to the RAM 107 and executing the programs. The region designation process of FIG. 16 is executed at a timing at which the generation process of the reference image is completed. Note that some or all of functions in the steps of FIG. 16 may be implemented by hardware such as an ASIC or an electronic circuit. A symbol “S” in explanation of each process means step in this flowchart. In S1601, the CPU 106 implements the image region setting module 202 to obtain positions of blank pixels from the print image. In S1602, the CPU 106 designates positions of not-blank pixels as the print image corresponding regions. In S1603, the CPU 106 designates the positions of blank pixels as the pre-printed image corresponding regions. The processes of S1601 to S1063 described above allow only the regions where the print images are present to be all designated as the print image corresponding regions.

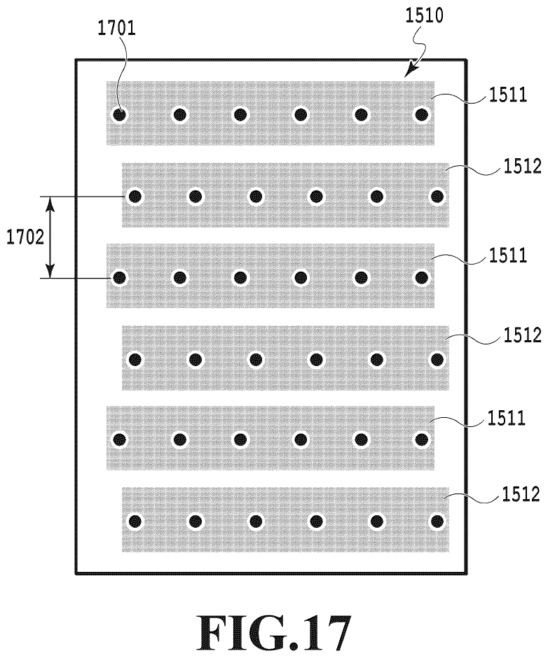

Next, explanation is given of a method of arranging the control points in a print product in which print image corresponding regions are distributed at multiple positions in a sheet. In order to perform alignment using the control points on positional shift as illustrated in the inspection target image 1510 of FIG. 15B, at least one control point need to be arranged in each of the print image corresponding regions 1512 and the pre-printed image corresponding regions 1511. For example, in FIG. 17, each of the print image corresponding regions 1512 and the pre-printed image corresponding regions 1511 includes at least one control point 1701. A characteristic of the present embodiment is to determine a control point interval 1702 such that at least one control point is arranged in each region. For example, the control point interval 1702 in the sub-scanning direction is set to be smaller than the length of the smallest print image corresponding region in the sub-scanning direction.

In the present embodiment, this is achieved as follows. In S802 in which the control points are arranged, the number L of control points in one column is adjusted such that the control point interval obtained from the image size and the number L of control points in one column is smaller than the length of the smallest print image corresponding region in the sub-scanning direction.

In the embodiment described above, the designation of the print image corresponding regions is performed based on the print images. All regions in which the print image information is present can be thereby designated as the print image corresponding regions.

Moreover, in the above-mentioned embodiment, the number L of control points in one column is adjusted such that the control point interval obtained from the image size and the number L of control points in one column is smaller than the length of the smallest print image corresponding region in the sub-scanning direction. Furthermore, the number M of control points in one row is adjusted such that the control point interval obtained from the image size and the number M of control points in one row is smaller than the length of the smallest print image corresponding region in the main scanning direction. At least one control point can be thereby arranged in each region.

### Third Embodiment

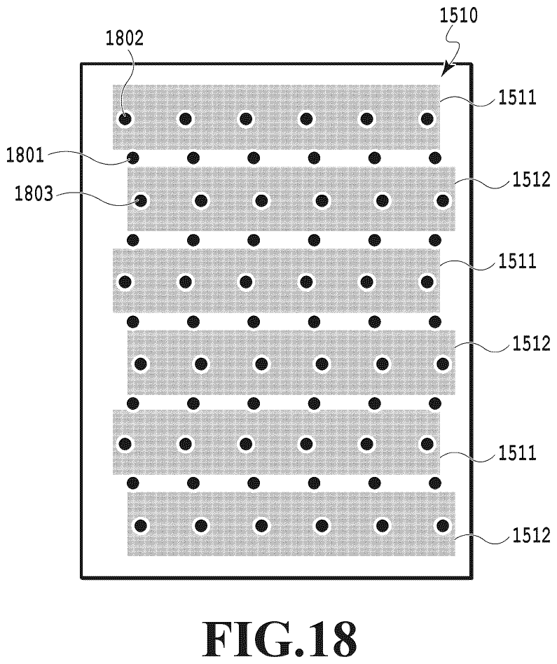

In a third embodiment, explanation is given of the control point position correction process in the case where the control points are arranged near a boundary between the pre-printed image corresponding region and the print image corresponding region. Description is given of the case where there is a positional shift between the pre-printed image and the print image due to shifting of a position where the printing apparatus 102 forms the print image on the pre-printed sheet. FIG. 18 illustrates an example in which control points are arranged near a boundary between the pre-printed image corresponding region 1511 and the print image corresponding region 1512 like control points 1801 in the inspection target image 1510 of FIG. 17. The control points 1801 near the boundary between the pre-printed image corresponding region 1511 and the print image corresponding region 1512 are updated in the update process of the control points to control positional shift in both of the pre-printed image and the print image. Accordingly, the positions of the control points 1801 are not updated to coincide with one of the positional shift of control points 1802 in the pre-printed image corresponding region and the positional shift of control points 1803 in the print image corresponding region. The positions of the control points 1801 are updated to intermediate positions in a positional shift direction of both images. Accordingly, in the control point position correction process, more ideal approximate lines can be calculated in the case where the control points 1801 near the region boundary are not used for the approximate line calculation. Furthermore, since the control points 1801 are updated to optimal positions, the correction accuracy of alignment can be improved in the case where the positions of the control points 1801 are not corrected to the approximate lines. A characteristic of the present embodiment is to remove the control points near the boundary of regions from the calculation of approximate lines and not to perform the position correction on the control points near the boundary of regions.

### [Details of S806 of FIG. 8]

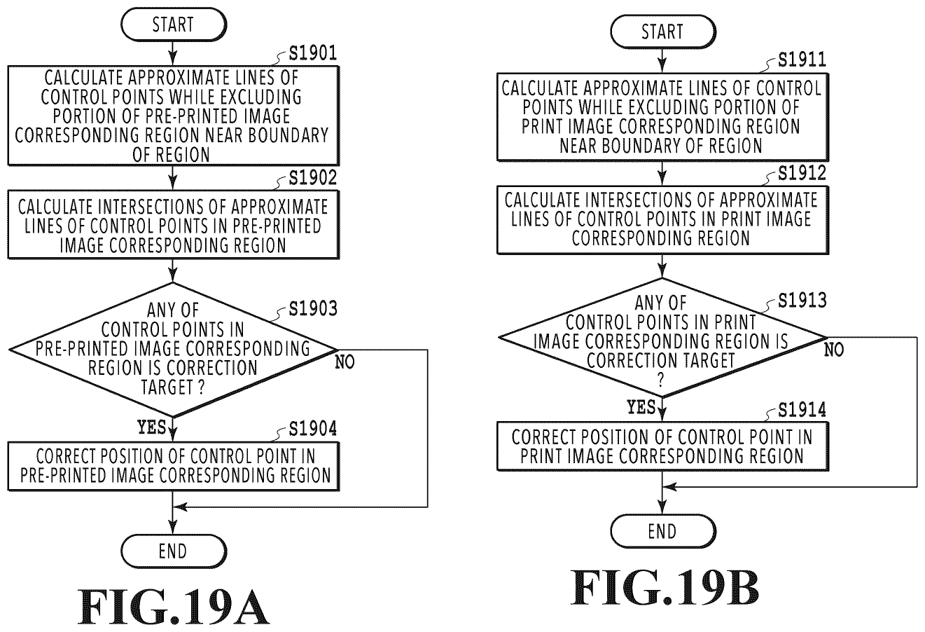

FIG. 19A is a flowchart explaining the third embodiment of the control point position correction process in S806 of FIG. 8. FIG. 19A is a modification of the control point position correction process illustrated in FIG. 13A. The CPU 106 implements the control point position correction process of FIG. 19A by reading out the programs stored in the ROM 108 to the RAM 107 and executing the programs. The control point position correction process of FIG. 19A is executed at a timing at which the process of S806 of FIG. 8 is started. Note that some or all of functions in the steps of FIG. 19A may be implemented by hardware such as an ASIC or an electronic circuit. A symbol “S” in explanation of each process means step in this flowchart. Hereinafter, points different from the first embodiment are explained.

In S1901, the CPU 106 implements the alignment process module 204 to calculate the approximate lines of the control points while excluding a portion of the pre-printed image corresponding region near the boundary of the pre-printed image corresponding region. The position of each control point is updated based on a differential value of a sum of squares of differences between the pixel values of the alignment image and the pixel values of the reference image in the set of positions of pixels near the control point as in formula (2). Specifically, in the case where the distance between the control point and a boundary position of the pre-printed image corresponding region is smaller than a predetermined distance, the CPU 106 determines that this control point is a control point near the boundary, and excludes this control point from the calculation of approximate lines. In S1903, the CPU 106 implements the alignment process module 204 to determine whether each of the control points in the pre-printed image corresponding region is the correction target or not. In the case where a distance between this control point among the control points used in the calculation of approximate lines in S1901 and an intersection obtained in S1902 exceeds a predetermined value, the CPU 106 determines that this control point is a correction target. In the case where the distance between this control point and the intersection obtained in S1902 is equal to or smaller than the predetermined value, the CPU 106 determines that this control point is not a correction target.

### [Details of S807 of FIG. 8]

FIG. 19B is a flowchart explaining the third embodiment of the control point position correction process in S807 of FIG. 8. Since a specific flow of the process is the same as that of the control point position correction process targeted at the control points in the pre-printed image corresponding region, explanation thereof is omitted.

In the above-mentioned embodiment, the CPU 106 calculates the approximate lines of the control points while excluding the portion of the pre-printed image corresponding region near the boundary of the pre-printed image corresponding region. Moreover, the CPU 106 calculates the approximate lines of the control points while excluding a portion of the print image corresponding region near the boundary of the print image corresponding region. The CPU 106 can thereby calculate more ideal approximate lines in each of the regions. Moreover, the CPU 106 determines that the control points used in the calculation of approximate lines are correction targets, and determines that the control points not used in the calculation of approximate lines are not correction targets. This can prevent the case where the control points already updated to the optimal positions are further corrected. As a result, a decrease in alignment accuracy can be prevented also in the case where the control points are arranged near the boundary between the pre-printed image corresponding region and the print image corresponding region.

### Another Implementation Method

Note that the present disclosure may be applied to a system formed of multiple devices such as, for example, a host computer, an interface device, a reader, and a printer, or applied to an apparatus formed of one device such as, for example, a copier or a facsimile.

### Other Embodiments

Although the present disclosure has been explained above while displaying various examples and embodiments of the present disclosure, the spirit and scope of the present disclosure are not limited to the specific explanation in the present specification. The present disclosure is not limited to the above-mentioned embodiments, and various modifications can be made. Moreover, in the present disclosure, parts of the above-mentioned embodiments may be combined as appropriate.

### Modified Example 1

For example, although the example in which the CPU 106 implements the configurations of the respective software modules in the inspection apparatus 105 of FIG. 1 is explained, the present disclosure is not limited to this. For example, a CPU (not illustrated) of the printing apparatus 102 may implement the configurations of the software modules in the inspection apparatus 105 of FIG. 1. Alternatively, an apparatus outside the inspection system 100 may implement the configurations of the software modules in the inspection apparatus 105 of FIG. 1. Examples of such an apparatus outside the inspection system 100 include various terminals such as a smartphone, a tablet terminal, and a personal computer. Alternatively, a cloud service that is connected to the inspection system 100 via the Internet (not illustrated) and that can provide various services may implement the configurations of the software modules in the inspection apparatus 105 of FIG. 1. Note that an apparatus including several configurations of the inspection apparatus 105 may be referred to as an image processing apparatus.

### Modified Example 2

For example, although the example in which the reference image 430 of FIGS. 4A to 4D includes the print image region 403 and the pre-printed image region 404 arranged in this order from the top to the bottom of the sheet is explained, the present disclosure is not limited to this. For example, the configuration may be such that multiple pre-printed image regions 404 are set to be scattered on the sheet, and multiple print image regions 403 are set between the multiple pre-printed image regions 404.

### Modified Example 3

For example, although the example in which the character information of the postal code, the address, and the name are rendered as the print image information 401 is explained in FIGS. 4A to 4D, the present disclosure is not limited to this. For example, a picture may be rendered as the print image information 401.

### Modified Example 4

For example, although the example in which the picture 402 is rendered in the pre-printed image region 404 is explained in FIGS. 4A to 4D, the present disclosure is not limited to this. For example, rule lines and frames may be rendered to surround the print image information 401 in the pre-printed image region 404.

### Modified Example 5

For example, although the configuration example in which the control points are arranged in the lattice pattern is explained, the present disclosure is not limited to this. For example, a configuration in which the control points are arranged in a web pattern may be employed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-077731, filed on May 13, 2024, which is hereby incorporated by reference herein in its entirety.

What is claimed is:

1. An image processing apparatus comprising:
an image obtaining unit configured to read a print product in which a print image is printed on a pre-printed sheet and generate an inspection target image of the print product;
a first alignment unit configured to generate an alignment image by aligning the inspection target image as a whole with a reference image by means of projection transformation, the reference image indicating a correct image of the inspection target image; and
a second alignment unit configured to perform alignment by means of non-rigid registration in each of local regions of the alignment image, wherein
the second alignment unit uses at least one of a print image region surrounding the print image and a pre-printed image region surrounding a pre-printed image printed on the pre-printed sheet before printing of the print image in the alignment image as the local regions.

2. The image processing apparatus according to claim 1, further comprising an inspection result output unit configured to output an inspection result of the print product inspected based on the reference image and on an already-aligned image subjected to the alignment of the alignment image by the second alignment unit.

3. The image processing apparatus according to claim 2, further comprising a reference image generation unit configured to generate the reference image based on first image information for generating the pre-printed image and second image information for generating the print image.

4. The image processing apparatus according to claim 3, further comprising a reference image generation unit configured to generate the reference image by overwriting a not-blank pixel among a plurality of pixels forming the print image on a converted image obtained by subjecting the pre-printed image to conversion in which four corners of the pre-printed image are aligned to match four corners of the print image.

5. The image processing apparatus according to claim 3, further comprising:
a pre-printed image obtaining unit configured to obtain the first image information; and
a print image obtaining unit configured to obtain the second image information, wherein
the reference image generation unit generates the reference image based on the first image information obtained by the pre-printed image obtaining unit and the second image information obtained by the print image obtaining unit.

6. The image processing apparatus according to claim 4, further comprising an output pre-printed image obtaining unit configured to obtain the pre-printed image by reading the pre-printed sheet.

7. The image processing apparatus according to claim 4, wherein
the second alignment unit further includes a control point control unit configured to control a control point group formed of a plurality of control points arranged on the inspection target image,
the plurality of control points are arranged in a lattice pattern in a predetermined coordinate system,
the inspection target image is set in the predetermined coordinate system, and
the control point control unit controls the control point group and moves at least one of the plurality of control points to transform the predetermined coordinate system and the inspection target image such that the transformation follows the movement.

8. The image processing apparatus according to claim 7, wherein the control point control unit performs control of adjusting an interval between each of the plurality of control points based on the number of control points in the control point group in a column direction, the number of control points in the control point group in a row direction, and an image size of the alignment image.

9. The image processing apparatus according to claim 8, wherein
the second alignment unit further includes an updating unit configured to update a position of an update target control point in the control point group based on pixels of the reference image and pixels of the alignment image, and
the control point control unit transforms a shape of the inspection target image to a shape of the alignment image in accordance with an update of the update target control point by the updating unit.

10. The image processing apparatus according to claim 9, wherein the second alignment unit further includes a pixel updating unit configured to update pixels of inspection target image to the pixels of alignment image in accordance with an update of the update target control point by the updating unit.

11. The image processing apparatus according to claim 10, wherein the second alignment unit further includes an approximate line calculation unit configured to calculate each of a first approximate line extending along the column direction and a second approximate line extending along the row direction, based on two or more of the control points selected from the control point group arranged in the same region as the local region in a case where one control point selected from the control point group is arranged in one of the local regions.

12. The image processing apparatus according to claim 11, wherein the approximate line calculation unit excludes the control point arranged within a predetermined distance from a boundary of the local regions, in the control point group from the calculation of each of the first approximate line and the second approximate line.

13. The image processing apparatus according to claim 11, wherein the approximate line calculation unit uses at least one of an approximate straight line and an approximate curve as each of the first approximate line and the second approximate line.

14. The image processing apparatus according to claim 11, wherein the second alignment unit further includes a correction target setting unit configured to set the control point arranged at a position away from an intersection of the first approximate line and the second approximate line by more than a predetermined distance, in the control point group as a correction target.

15. The image processing apparatus according to claim 11, wherein the second alignment unit further includes a boundary correction target setting unit configured to set the control point arranged at a position away from a boundary of the local regions by more than a predetermined distance, in the control point group as a correction target.

16. The image processing apparatus according to claim 14, wherein the second alignment unit further includes a correction unit configured to correct the position of the control point set as the correction target to a position of the intersection.

17. The image processing apparatus according to claim 16, wherein the second alignment unit further includes an image generation unit configured to transform a shape of the inspection target image to a shape of the alignment image depending on a change of the position of the control point corrected by the correction unit.

18. The image processing apparatus according to claim 1, further comprising an image region setting unit configured to designate the pre-printed image region and the print image region based on user set regions set by a user.

19. The image processing apparatus according to claim 18, wherein the image region setting unit designates the print image region based on a region including not-blank pixels among pixels forming the print image, and designates the pre-printed image region based on a region including blank pixels among the pixels forming the print image.

20. An image processing method comprising:
reading a print product in which a print image is printed on a pre-printed sheet and generating an inspection target image of the print product;
generating an alignment image by aligning the inspection target image as a whole with a reference image by means of projection transformation, the reference image indicating a correct image of the inspection target image; and
performing alignment by means of non-rigid registration in each of local regions of the alignment image, wherein
in the performing alignment, at least one of a print image region surrounding the print image and a pre-printed image region surrounding a pre-printed image printed on the pre-printed sheet before printing of the print image in the alignment image is used as the local regions.
